(19) United States
(12) Patent Application Publication
(10) Pub. No.: US 2020/0408623 A1
(43) Pub. Date: Dec. 31, 2020

(54) APPARATUS AND METHOD FOR DETECTING IMPACT USING SPEAKER FOR VEHICLE

(71) Applicants: HYUNDAI MOTOR COMPANY, Seoul (KR); KIA MOTORS CORPORATION, Seoul (KR)

(72) Inventor: Byoung Yoon KIM, Seoul (KR)

(21) Appl. No.: 16/663,216

(22) Filed: Oct. 24, 2019

(30) Foreign Application Priority Data
Jun. 27, 2019 (KR) 10-2019-0077289

(51) Int. Cl. G01L 5/00; G01L 1/14; G01S 19/03; H04R 1/02; H04R 1/40; H04R 3/12; H04R 9/06; H04N 5/232

(52) U.S. Cl. CPC G01L 5/0052; G01L 1/14; G01S 19/03; H04R 1/025; H04R 2499/13; H04R 3/12; H04R 9/06; H04N 5/232; H04R 1/403

(57) ABSTRACT

An apparatus and a method for detecting an impact using a speaker mounted in a vehicle, the apparatus includes at least two or more speakers mounted on different locations in a vehicle and a processing device that receives an induction current output from each of the at least two or more speakers when an external impact occurs on the vehicle, determines a current level of the induction current, and determines at least one of an intensity level of the impact or an impact location of the external impact based on the current level.

### CROSS-REFERENCE TO RELATED APPLICATION

This application is based on and claims the benefit of priority to Korean Patent Application No. 10-2019-0077289, filed on Jun. 27, 2019 in the Korean Intellectual Property Office, the entire contents of which are incorporated herein by reference.

### TECHNICAL FIELD

The present disclosure relates to an apparatus and method for detecting an impact using a speaker for vehicle.

### BACKGROUND

When an impact occurs from the outside to a vehicle, an impact detection system may detect the impact applied to the vehicle by means of an impact sensor and may deliver the detected impact to an in-vehicle control device such as an airbag control device. It is possible for such an impact detection system to detect only an impact and it is impossible for the impact detection system to determine a vehicle portion to which the impact is applied. Furthermore, the impact sensor of the impact detection system may continue consuming a dark current, thus causing a battery discharge problem.

### SUMMARY

The present disclosure has been made to solve the above-mentioned problems occurring in the prior art while advantages achieved by the prior art are maintained intact.

An aspect of the present disclosure provides an apparatus and method for detecting an impact using a speaker for vehicle to detect an impact applied from the outside to a vehicle using speakers mounted on the vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for detecting an impact may include: at least two or more speakers mounted on different locations in a vehicle and a processing device that receives an induction current output from each of the at least two or more speakers when an external impact occurs on the vehicle, determines a current level of the induction current, and determines at least one of an intensity level of the external impact or an impact location based on the current level.

Each of the at least two or more speakers may include a diaphragm that generates vibration due to the external impact, a voice coil that generates a displacement due to the vibration of the diaphragm, a magnet that generates an induced electromotive force through interaction with the voice coil, and a resistor that is connected to the voice coil and generates an induction current by the induced electromotive force.

The apparatus may further include a memory storing a lookup table defining an induction current according to the intensity level. The processing device may determine the intensity level according to the current level of the induction current output from each of the at least two or more speakers with reference to the lookup table.

The processing device may detect at least one or more speakers, each of which has a relatively higher intensity level among the at least two or more speakers, by comparing intensity levels detected for the at least two or more speakers, and may determine the impact location based on respective locations where the at least one or more speakers are mounted.

The processing device may extract at least one or more speakers, each of which outputs an induction current with a relatively higher current level among the at least two or more speakers by comparing current levels of the induction current output from the at least two or more speakers, and may determine the impact location based on respective locations where the at least one or more extracted speakers are mounted.

The apparatus may further include a communication device that communicates with an in-vehicle control device loaded into the vehicle. The processing device may transmit impact detection information including the at least one of the intensity level or the impact location to the in-vehicle control device.

The in-vehicle control device may include at least one of a drive video record system (DVRS) or an audio video navigation telematics (AVNT).

The DVRS may record an image around the impact location using a camera.

The AVNT may obtain a vehicle location and time information by means of a global positioning system (GPS) and may transmit the impact detection information and the obtained vehicle location and time information to at least one of an information collection center or a user terminal.

According to another aspect of the present disclosure, a method for detecting an impact using at least two or more speakers mounted on different locations in a vehicle may include: receiving an induction current output from each of the at least two or more speakers, when an external impact occur on the vehicle, determining a current level of the induction current output from each of the at least two or more speakers, and determining at least one of an intensity level of the external impact or an impact location based on the current level.

The receiving an induction current may include generating a displacement in a voice coil of each speaker by generating vibration in a diaphragm of each speaker due to the external impact and generating the induction current in a resistor connected to the voice coil by generating an induced electromotive force through interaction between the voice coil and a magnet of each speaker.

The determining at least one of an intensity level of the external impact or an impact location may include determining the intensity level according to the current level of the induction current output from each speaker with reference to a lookup table defining an induction current according to the intensity level.

The determining at least one of an intensity level of the external impact or an impact location may include detecting at least one or more speakers, each of which outputs an induction current with a relatively high current level, by comparing the current levels of the induction currents output from the at least two or more speakers and determining the impact location based on locations of the at least one or more detected speakers.

The method may further include transmitting impact detection information including at least one of the intensity level or the impact location to an in-vehicle control device.

The transmitting may include transmitting the impact detection information to at least one of a drive video record system (DVRS) or an audio video navigation telematics (AVNT).

The DVRS may record an image around the impact location by means of a camera when receiving the impact detection information.

The AVNT may obtain a vehicle location and time information by means of a GPS and may transmit the obtained vehicle location and time information together with the impact detection information to at least one of an information collection center or a user terminal.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for detecting an impact according to an exemplary embodiment of the present disclosure;

FIG. 2 is a drawing illustrating an example of mounting speakers associated with an exemplary embodiment of the present disclosure;

FIG. 3 is a drawing illustrating a structure of a speaker shown in FIG. 1;

FIG. 4 is a graph illustrating a generated current according to an intensity level of an impact associated with an exemplary embodiment of the present disclosure; and

FIG. 5 is a flowchart illustrating a method for detecting an impact according to an exemplary embodiment of the present disclosure.

### DETAILED DESCRIPTION

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure relates to technologies of detecting an impact which occurs from the outside of a vehicle using a plurality speakers mounted on the vehicle. Particularly, the present disclosure may determine an intensity level of the impact based on a level of an induction current generated due to movement (vibration) of a diaphragm in a speaker by an impact when the impact occurs and may determine an impact location using a location where a speaker which detects the impact is mounted in the vehicle

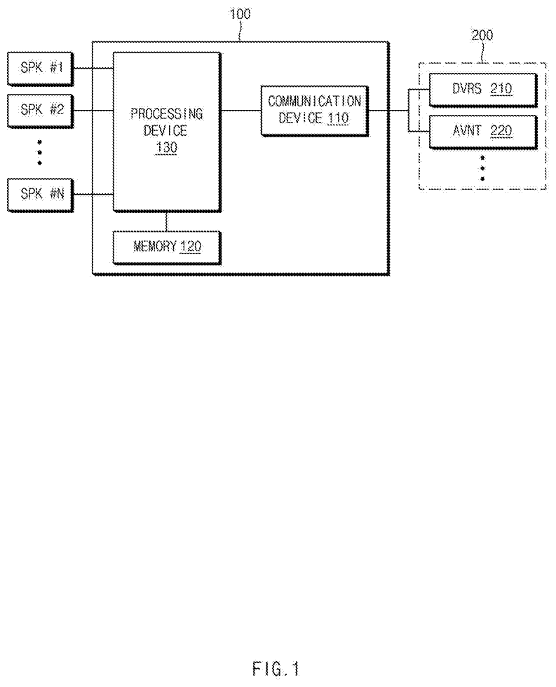

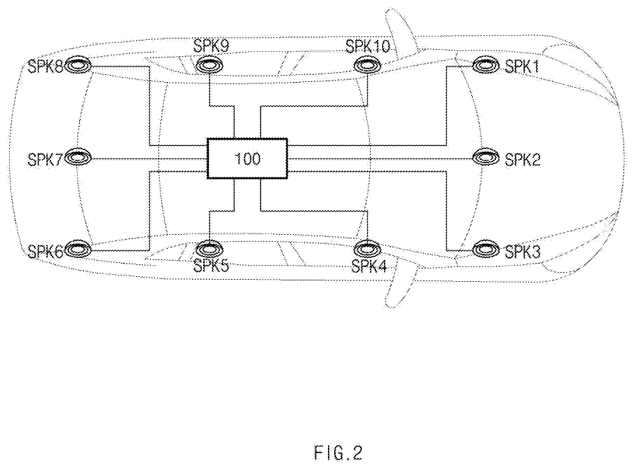

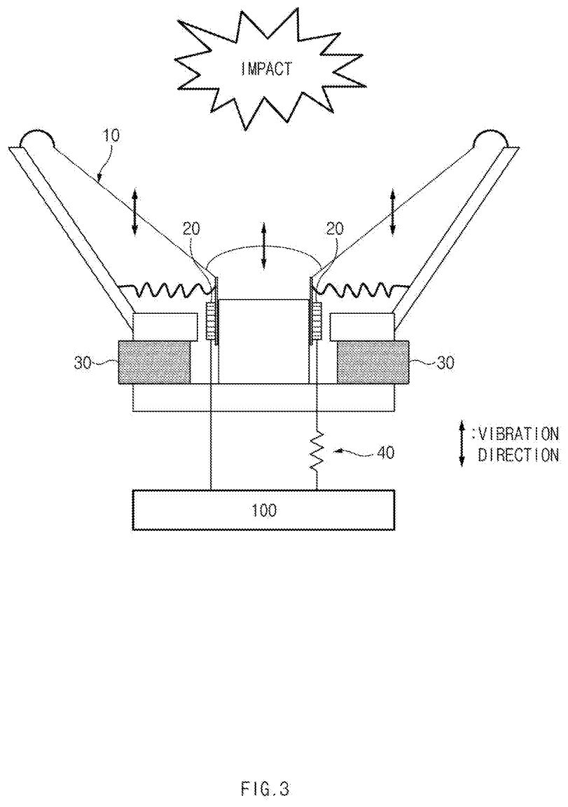

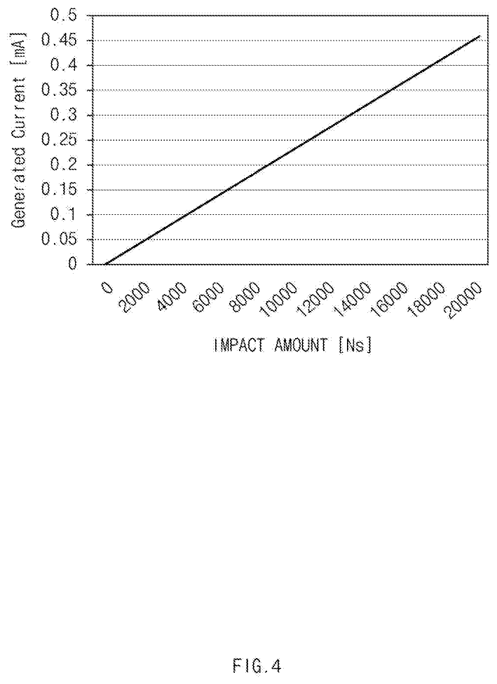

FIG. 1 is a block diagram illustrating a configuration of an apparatus for detecting an impact according to an exemplary embodiment of the present disclosure. FIG. 2 is a drawing illustrating an example of mounting speakers associated with an exemplary embodiment of the present disclosure. FIG. 3 is a drawing illustrating a structure of a speaker shown in FIG. 1. FIG. 4 is a graph illustrating a generated current according to an intensity level of the impact associated with an exemplary embodiment of the present disclosure.

An apparatus 100 for detecting an impact may play a role in detecting an impact which occurs from the outside of a vehicle by means of a plurality of speakers mounted on the vehicle or amplifying an audio signal. Such an apparatus 100 may detect an impact (hereinafter referred to as “external impact”) applied from the outside to the vehicle using at least two or more speakers SPK #1 to SPK #N mounted on the vehicle. The at least two or more speakers SPK #1 to SPK #N may be arranged on different locations in the vehicle. For example, as shown in FIG. 2, three speakers SPK1, SPK2, and SPK3 and three speakers SPK6, SPK7, and SPK8 may be mounted on the front and the rear of the vehicle, respectively. The speakers SPK10, SPK4, SPK9, and SPK5 may be mounted on a driver seat door, a passenger seat door, a driver side rear seat door, and a passenger side rear seat door, respectively.

Each speaker may be used as an impact sensor which senses an impact in a state where the vehicle stalls, as well as a sound output device which generates a sound. As shown in FIG. 3, such each speaker may include a diaphragm (cone paper) 10, a voice coil 20, a magnet 30, and a resistor 40.

The diaphragm 10 may play a role in vibrating air to generate a sound. The diaphragm 10 may be made of a material such as paper, polymer laminate, polypropylene, or cross carbon.

When an external impact is generated, vibration may occur in the diaphragm 10 by the generated external impact. For example, when an impact is generated on a portion where a speaker is mounted, the diaphragm 10 may vibrate due to the generated impact.

The voice coil 20 may be attached to the diaphragm 10 to receive an audio signal, that is, an electrical signal and deliver the received audio signal to the diaphragm 10. The voice coil 20 may be moved up and down by an electromagnetic force which occurs when current is supplied to the voice coil 20. The diaphragm 10 may be moved up and down due to the up-and-down motion of the voice coil 20 to vibrate air and generate a sound due to the vibration.

Furthermore, the displacement of the voice coil 20 may be generated due to movement of the diaphragm 10, that is, vibration. In other words, the voice coil 20 may be moved together according to movement of the diaphragm 10. A back electromotive force may occur due to electromagnetic induction according to the movement of the voice coil 20.

The magnet 30 may play a role in inducing the voice coil 20 to move up and down due to an electromagnetic force. The magnet 30 may generate an induced electromotive force, that is, a back electromotive force, through interaction with the voice coil 20.

The resistor 40 may be connected to the voice coil 20 to generate an induction current due to an induced electromotive force. In other words, the induction current by the induced electromotive force flows in the resistor 40.

The apparatus 100 for detecting the impact may include a communication device 110, a memory 120, and a processing device 130.

The communication device 110 may transmit and receive data over an in-vehicle network (IVN). The IVN may be implemented as a controller area network (CAN), a media oriented systems transport (MOST) network, a local interconnect network (LIN), X-by-wire (Flexray), and/or the like.

The communication device 110 may communicate with an in-vehicle control device 200 over the IVN. The in-vehicle control device 200 may include a drive video record system (DVRS) 210, an audio video navigation telematics (AVNT) 220, and the like.

The memory 120 may store software programmed for the processing device 130 to perform a predetermined operation. The memory 120 may store a lookup table or the like defining location information in a vehicle for each speaker and an induction current (or a generated current or the amount of generated current) according to an intensity level of an impact (an impact amount).

The memory 120 may be implemented with at least one of storage media (recording media), for example, a flash memory, a hard disk, a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), a register, or a removable disk.

The processing device 130 may control an overall operation of the apparatus 100 for detecting the impact. The processing device 130 may be implemented with at least one of an application specific integrated circuit (ASIC), a digital signal processor (DSP), programmable logic devices (PLD), field programmable gate arrays (FPGAs), a central processing unit (CPU), microcontrollers, or microprocessors.

When there is no input from at least two or more speakers SPK #1 to SPK #N during a predetermined time, the processing device 130 may convert an operation mode into a sleep mode. When there is an input from at least one or more speakers among at least two or more speakers in the sleep mode, the processing device 130 may wake up from the sleep mode.

When an external impact occurs, the processing device 130 may receive an induction current generated from each of the at least two or more speakers SPK #1 to SPK #N. When an impact is applied from the outside to a vehicle, a diaphragm 10 of each of the speakers SPK #1 to SPK #N arranged in the vehicle may vibrate. The vibration of the diaphragm 10 may cause a back electromotive force through the voice coil 20, thus causing an induction current by the back electromotive force.

The processing device 130 may determine (verify) a current level of an induction current output from each speaker. In other words, the processing device 130 may determine a level of an induction current input through each channel connected with each of the at least two or more speakers SPK #1 to SPK #N. The processing device 130 may determine an intensity level of the impact based on the level of the induction current output from each speaker. In other words, the processing device 130 may verify an intensity level of the impact detected for each speaker. For example, as shown in FIG. 4, when a generated current is 0.3 mA, the processing device 130 may determine an impact amount as 14000 Ns.

The processing device 130 may compare intensity levels of the impact detected for the at least two or more speakers to each other and may determine an impact location based on the compared result. The processing device 130 may compare current levels of the induction current output from the speakers to each other to verify a mounting location of a speaker which outputs an induction current with a relatively higher current level among the speakers. In other words, the processing device 130 may determine the mounting location of the speaker as an impact location, that is, a vehicle portion to which an impact is applied.

For example, when a current level of an induction current output from the passenger side door speaker SPK4 and the front right speaker SPK3 is relatively higher than that of an induction current output from the other speakers SPK1, SPK2, and SPK5 to SPK10, the processing device 130 may determine the impact location as the right front of the vehicle.

The processing device 130 may transmit (deliver) impact detection information including the intensity level and the impact location to the in-vehicle control device 200. In this case, the processing device 130 may determine whether the intensity level is greater than a predetermined reference intensity level and may transmit the impact detection information only when the intensity level is greater than the reference intensity level. The in-vehicle control device 200 may perform an application function based on the impact detection information. The in-vehicle control device 200 may be a computing system and may include a processor, a memory, a storage, an input device (e.g., a keyboard, a keypad, a touch pad, a touch screen, and/or the like), an output device (e.g., a display, a speaker, and/or the like), a network interface, and the like. The processor may be a central processing unit (CPU) or a semiconductor device which processes instructions stored in the memory and/or the storage. The memory and/or the storage may include various types of volatile and/or non-volatile storage media.

When receiving the impact detection information, the DVRS 210 of the in-vehicle control device 200 may record an image around the impact location by means of a camera (not shown) based on the impact location in the impact detection information. The DVRS 210 may select a camera capable of capturing a surrounding image including the impact location among at least one or more cameras mounted on the vehicle and may obtain image information by means of the selected camera. Furthermore, the DVRS 210 may store an image before impact detection and an image after impact detection during a predetermined time on the basis of an impact detection time. The DVRS 210 may store the image before the impact detection and the image after the impact detection in separate storage spaces.

When receiving the impact detection information, the AVNT 220 of the in-vehicle control device 200 may obtain a vehicle location and time information by means of a global positioning system (GPS). The AVNT 220 may transmit the vehicle location and the time information together with the impact detection information to an information collection center and/or a user terminal (e.g., a smartphone, a tablet, and/or the like) by means of a telematics unit (TMU).

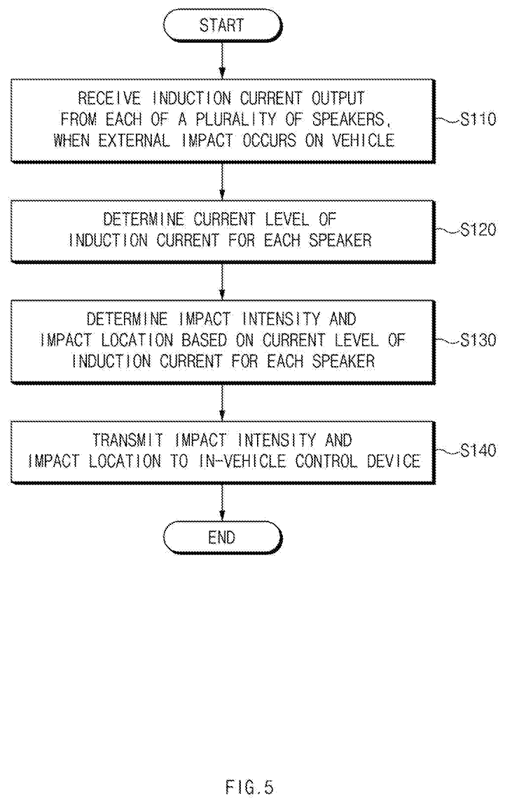

FIG. 5 is a flowchart illustrating a method for detecting an impact according to an exemplary embodiment of the present disclosure.

Referring to FIG. 5, in S110, when an external impact occurs, a processing device 130 of an apparatus 100 for detecting an impact in FIG. 1 may receive an induction current output from each of a plurality of speakers SPK #1 to SPK #N mounted on a vehicle. Herein, the plurality of speakers SPK #1 to SPK #N may be arranged on different locations in the vehicle and may include two or more speakers. When an impact is applied from the outside to the vehicle, a diaphragm 10 of each speaker may vibrate by the impact. Due to this vibration, a voice coil 20 attached to the diaphragm 10 may vibrate together. An induction current may occur in a resistor 40 connected to the voice coil 20 by a back electromotive force generated by the vibration (movement) of the voice coil 20. In other words, when an impact is generated on the outside of the vehicle, each speaker may output an induction current according to a back electromotive force (an induced electromotive force) generated by the generated impact.

In S120, the processing device 130 may determine a current level of an induction current for each speaker. The processing device 130 may verify a current level of an induction current output from each of the plurality of speakers SPK #1 to SPK #N.

In S130, the processing device 130 may determine an intensity level of the impact and an impact location based on the current level of the induction current for each speaker. The processing device 130 may determine an intensity level matched to a current level of an induction current output from each speaker with reference to a lookup table stored in a memory 120 of FIG. 1. In other words, the processing device 130 may determine (verify) an intensity level of the impact detected using each speaker. Furthermore, the processing device 130 may compare a plurality of intensity levels detected for the plurality of speakers SPK #1 to SPK #N and may determine an impact location based on the compared result. In other words, the processing device 130 may extract at least one or more speakers, each of which has a relatively high current level of an induction current, among the plurality of speakers SPK #1 to SPK #N and may verify a location where the extracted speaker is mounted in the vehicle with reference to location information in the vehicle for each speaker, stored in the memory 120, to determine an impact location.

In S140, the processing device 140 may transmit impact detection information including the intensity level and the impact location to the in-vehicle control device 200, such as a DVRS 210, an AVNT 220, or the like, via a communication device 110 of FIG. 1.

Thereafter, the DVRS 210 may interact with a camera at the impact location (an impact portion) based on the impact location included in the impact detection information to record an image near the impact location. In this case, the DVRS 210 may store the image captured by the camera in a separate storage space.

Furthermore, when receiving the impact detection information, the AVNT 220 may obtain a vehicle location and time information by means of a GPS. The AVNT 220 may transmit the vehicle location and the time information together with the impact detection information to an information collection center and/or a user terminal through a telematics unit (TMU).

According to exemplary embodiments of the present disclosure, the apparatus for detecting the impact may detect an impact applied from the outside to the vehicle using speakers mounted on the vehicle and may determine an intensity level of the impact and an impact location. Thus, the apparatus for detecting the impact may interact with a camera loaded into the vehicle to record an image around the impact location.

Furthermore, according to exemplary embodiments of the present disclosure, the apparatus for detecting the impact may detect an impact using a back electromotive force generated in a speaker by vibration due to an impact applied from the outside to the vehicle, thus being free from a battery discharge problem, although the vehicle is parked for a long time because there is no consumption of a dark current.

Furthermore, according to exemplary embodiments of the present disclosure, the apparatus for detecting the impact may save costs, because there is no need to install a separate impact sensor because of using a speaker basically mounted on the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the exemplary embodiments. The scope of the present disclosure should be construed on the basis of the accompanying claims, and all the technical ideas within the scope equivalent to the claims should be included in the scope of the present disclosure.

What is claimed is:

1. An apparatus for detecting an impact, the apparatus comprising:
at least two or more speakers mounted on different locations in a vehicle; and
a processing device configured to receive an induction current output from each of the at least two or more speakers when an external impact occurs on the vehicle, determine a current level of the induction current, and determine at least one of an intensity level of the external impact or an impact location of the external impact based on the current level.

2. The apparatus of claim 1, wherein each of the at least two or more speakers includes:
a diaphragm generating vibration due to the external impact;
a voice coil generating a displacement due to the vibration of the diaphragm;
a magnet generating an induced electromotive force through interaction with the voice coil; and
a resistor connected to the voice coil and generating an induction current by the induced electromotive force.

3. The apparatus of claim 1, further comprising:
a memory storing a lookup table defining an induction current according to the intensity level,
wherein the processing device determines the intensity level according to the current level of the induction current output from each of the at least two or more speakers with reference to the lookup table.

4. The apparatus of claim 1, wherein the processing device detects at least one or more speakers, each of which has a relatively higher intensity level among the at least two or more speakers, by comparing intensity levels detected for the at least two or more speakers, and determines the impact location based on respective locations where the at least one or more speakers are mounted.

5. The apparatus of claim 1, wherein the processing device extracts at least one or more speakers, each of which outputs an induction current with a relatively higher current level among the at least two or more speakers, by comparing current levels of the induction current output from the at least two or more speakers, and determines the impact location based on respective locations where the at least one or more extracted speakers are mounted.

6. The apparatus of claim 1, further comprising:
a communication device configured to communicate with an in-vehicle control device loaded into the vehicle,
wherein the processing device transmits impact detection information including the at least one of the intensity level or the impact location to the in-vehicle control device.

7. The apparatus of claim 6, wherein the in-vehicle control device includes at least one of a drive video record system (DVRS) or an audio video navigation telematics (AVNT).

8. The apparatus of claim 7, wherein the DVRS records an image around the impact location using a camera.

9. The apparatus of claim 7, wherein the AVNT obtains a vehicle location and time information by means of a global positioning system (GPS) and transmits the impact detection information and the obtained vehicle location and time information to at least one of an information collection center or a user terminal.

10. A method for detecting an impact using at least two or more speakers mounted on different locations in a vehicle, the method comprising:
receiving an induction current output from each of the at least two or more speakers when an external impact occur on the vehicle;
determining a current level of the induction current output from each of the at least two or more speakers; and
determining at least one of an intensity level of the external impact or an impact location based on the current level.

11. The method of claim 10, wherein the receiving an induction current includes:
generating a displacement in a voice coil of each speaker by generating vibration in a diaphragm of each speaker due to the external impact; and
generating the induction current in a resistor connected to the voice coil by generating an induced electromotive force through interaction between the voice coil and a magnet of each speaker.

12. The method of claim 10, wherein the determining at least one of an intensity level of the external impact or an impact location includes:
determining the intensity level according to the current level of the induction current output from each speaker with reference to a lookup table defining an induction current according to the intensity level.

13. The method of claim 10, wherein the determining at least one of an intensity level of the external impact or an impact location includes:
detecting at least one or more speakers, each of which outputs an induction current with a relatively high current level, by comparing the current levels of the induction currents output from the at least two or more speakers; and
determining the impact location based on locations of the at least one or more detected speakers.

14. The method of claim 10, further comprising:
transmitting impact detection information including at least one of the intensity level or the impact location to an in-vehicle control device.

15. The method of claim 14, wherein the transmitting includes:
transmitting the impact detection information to at least one of a drive video record system (DVRS) or an audio video navigation telematics (AVNT).

16. The method of claim 15, wherein the DVRS records an image around the impact location by means of a camera when receiving the impact detection information.

17. The method of claim 15, wherein the AVNT obtains a vehicle location and time information by means of a GPS and transmits the obtained vehicle location and time information together with the impact detection information to at least one of an information collection center or a user terminal.
